(19) United States
(12) Patent Application Publication
(10) Pub. No.: US 2011/0149593 A1
(43) Pub. Date: Jun. 23, 2011

(54) FIBRE OPTIC LIGHTING SYSTEM FOR DRINK TAPS

(76) Inventor: Carlos Fernandez-Espana Garcia, A Coruna (ES)

(21) Appl. No.: 11/996,456

(22) PCT Filed: May 19, 2006
(86) PCT No.: PCT/ES2006/000268

§ 371 Date: Jun. 27, 2008

(30) Foreign Application Priority Data
Jul. 22, 2005 (ES) U200501787

(51) Int. Cl. F21V 29/00; F21V 13/02

(52) U.S. Cl. 362/558

(57) ABSTRACT

The invention relates to a fiber optic lighting system for drink taps. The inventive system consists of an external light-emitting core from which light is conveyed by means of fiber optic into a drink tap comprising a rigid plate to which the fiber optic is fixed. The aforementioned plate is placed inside a structure which is made from a light-diffusing material and which is covered with a light-refracting resin. The external light-emitting core is formed by a ventilator (6), inlet (8) and outlet (7) ventilation conduits, a halogen lamp (1), a flashing and/or colored disk (2) which rotates by means of a motor (3) and a harness of fiber optic cables (4) which are joined at an optical port (5).

### OBJECT OF THE INVENTION

The present specification relates to a Utility Model relating to a fiber optic lighting system for drink taps, the purpose of which is to continuously project points of flashing and/or color changing light inside the drink tap. At the same time it prevents the transmission of heat emitted by the light inside the actual tap.

The system is made up of a light emitter located in the outer part of the drink tap, connected to the mains power supply, and of a harness of fiber optic cables through which the light is conveyed from the light emitter to the drink tap cavity where the fiber optic cables are housed and distributed to obtain the desired lighting.

### FIELD OF THE INVENTION

This fiber optic lighting system can be applied in the industry dedicated to the manufacture of apparatuses and instruments for light conduction, distribution, transformation, regulation and control.

### BACKGROUND OF THE INVENTION

The applicant is aware of the existence today of a plurality of apparatuses and instruments for electricity and light conduction, distribution, accumulation, regulation and control.

The applicant is also aware of the existence of decorative and functional fiber optic lighting systems operating through a light-emitting core and a harness of fiber optics.

Today there is conventional lighting for display cases, closets and cooling chambers using discharge, incandescent, fluorescent and halogen lamps. There are also conventional types of colored light-emitting lamps.

These traditional systems do not allow the light to flash and change colors. These systems furthermore generate heat inside the actual drink tap cavity, whereby causing an unwanted increase of the temperature of the pipe carrying the liquid.

The obvious solution to the drawbacks existing today in this matter would be to have a lighting system that allowed flashing and color change inside the actual drink tap. The fiber optic system further allows extracting a heat source from inside the drink tap since the lighting fiber optic does not transmit heat.

However, the applicant is not aware of the current existence of an invention that allows color changing and/or flashing lighting that is adapted to drink taps which in turn carries out the function of preventing a temperature increase inside the drink tap.

### DESCRIPTION OF THE INVENTION

The fiber optic lighting system for drink taps proposed by the invention is configured as an evident novelty that allows the inner lighting of drink taps with color changing and/or flashing light. The fiber optic lighting system in turn does not generate heat inside the actual drink tap, since the light-emitting and heat-generating focal point is outside of such tap and the fiber optic cables propagate the light from the external light emitter towards the cavity without transmitting heat.

More specifically, the fiber optic lighting system for drink taps object of the invention comprises a closed external light-emitting core containing a ventilator, the lamp, the motor for rotating the flashing and/or colored disk and the flashing and/or colored disk itself, which will be responsible for producing the color change and/or the flashing inside the drink tap. A series of fiber optic cables conveying said light to the drink tap cavity come out of this emitting core; these fibers are fixed on a rigid plate located inside the tap cavity, which has a pipe attached thereto that may or may not be thermally insulated and through which the drink circulates. This plate is in turn enclosed inside a structure made from light-diffusing material to which resin is fixed therearound with light-refracting properties. This assembly basically forms the lighted structure of the tap.

Three sheets of drawings are attached to the present specification as an integral part thereof, showing the following with an illustrative and non-limiting character:

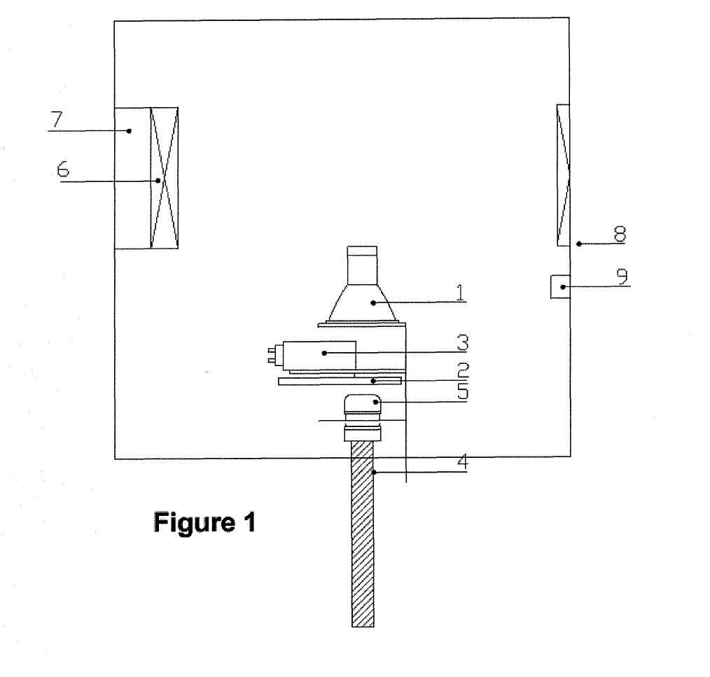

FIG. 1 shows an upper view of the external drink tap light emitter.

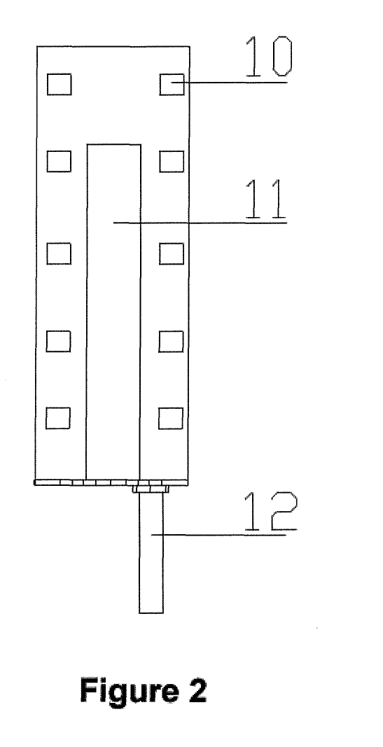

FIG. 2 shows the front of the plate inside the inventive system where the fiber optic for lighting the drink tap is fixed.

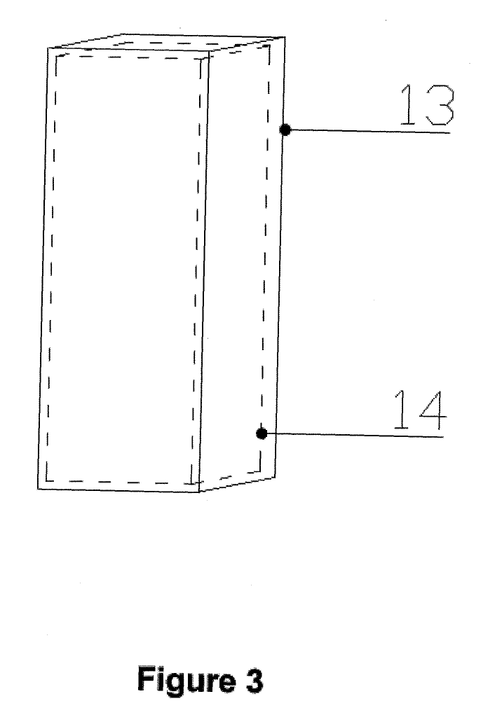

FIG. 3 shows the housing of the tap formed by the light-refracting material plus the also light-refracting resin.

### PREFERRED EMBODIMENT OF THE INVENTION

A breakdown of the fiber optic lighting system for drink taps can be observed in FIGS. 1, 2 and 3, said system comprising an external emitting core outside the tap connected to the mains power supply, said emitter being enclosed in a casing with forced ventilation through an air inlet (8) and an air outlet (7), the emitter further comprising a ventilator (6), a halogen lamp (1), a flashing and/or colored disk (2) rotating through a motor (3) and a harness of fiber optic cables (4) which are joined at an optical port (5) that will receive the light from the halogen lamp (1). The harness of fiber optic cables (4) distributes the fiber optic cables (12) to the different fixing points (10) arranged on the rigid plate (FIG. 2) inside the tap for fixing the fiber optic cable; said plate will be covered with a structure which is made from a light-diffusing material (14) in turn coated with light-refracting resin (13), see FIG. 3.

It is considered unnecessary to extend this description so that a person skilled in the art may understand the scope of the invention and the advantages derived from it.

The materials, shape, size and arrangement of the elements may vary provided that this does not alter the essential features of the invention.

The terms used in this description must always be interpreted in a broad and non-limiting manner.

1. A fiber optic lighting system for drink taps, wherein an external light-emitting core from which light is conveyed by means of fiber optic to the inside of a drink tap, comprising a rigid plate to which the fiber optic is fixed and this plate in turn is placed inside a structure which is made from a light-diffusing material covered by a light-refracting resin.

2. A fiber optic lighting system for drink taps according to claim 1, wherein an external light emitter formed by a ventilator, inlet and outlet ventilation conduits, a halogen lamp, a flashing and/or colored disk rotating through a motor and a harness of fiber optic cables which are joined at an optical port.

3. A fiber optic lighting system for drink taps according to claim 1, wherein a rigid plate containing a thermally insulated or non-thermally insulated pipe, by a harness of fiber optic distributing the fiber optic cables to the different fixing points located on a rigid plate through which the light will be conducted to the inside of the drink tap.

4. A fiber optic lighting system for drink taps according to claim 1, wherein a housing inside of which the rigid plate is introduced, this housing being formed by a light-diffusing material in turn coated with a light-refracting resin.
